(19) United States
(12) Patent Application Publication
(10) Pub. No.: US 2015/0308979 A1
(43) Pub. Date: Oct. 29, 2015

(54) SEQUENCER SYSTEM FOR DATA COLLECTION OF CORROSION SPECIMENS

(71) Applicant: KING FAHD UNIVERSITY OF PETROLEUM AND MINERALS, Dhahran (SA)

(72) Inventors: SAHEED KOLAWOLE ADEKUNLE, AL-KHOBAR (SA); AHMED ADEBOWALE ADENIRAN, AL-KHOBAR (SA); MOHAMMED MASLEHUDDIN, DHAHRAN (SA)

(21) Appl. No.: 14/698,745

(22) Filed: Apr. 28, 2015

Related U.S. Application Data
(60) Provisional application No. 61/984,863, filed on Apr. 28, 2014.

(51) Int. Cl. G01N 27/48; G01N 27/30

(52) U.S. Cl. CPC G01N 27/48; G01N 27/30

(57) ABSTRACT

The sequencer system for corrosion data collection of specimens includes a container for holding a plurality of specimens to be tested. During testing, the container holds a solution bath. A reference electrode and a counter electrode are coupled to a potentiostat, both electrodes being operationally disposed inside the container. A sequencer is connected to each specimen via a working electrode line. The sequencer operates in concert with the potentiostat to switch between a tested specimen and a subsequent specimen to be tested during a pause phase between each polarization cycle of the potentiostat. A computer is coupled to the potentiostat and the sequencer, and a program controls synchronized operations between the potentiostat and the sequencer. The program also permits automatic data collection for each of the specimens.

### CROSS REFERENCE TO RELATED APPLICATIONS

This application claims priority to a U.S. provisional patent application Ser. No.

61/984,863, filed on Apr. 28, 2014.

### BACKGROUND OF THE INVENTION

1. FIELD OF THE INVENTION

The present invention relates to monitoring and testing systems, and particularly to a sequencer system for data collection of corrosion specimens that provides serial testing of a plurality of specimens in a single session.

2. DESCRIPTION OF THE RELATED ART

Metallic corrosion is an electro-chemical process in which a metal loses mass at its surface due to formation of oxides. The time rate of the metal per unit of surface area defines the metallic corrosion rate. Given the economic and social importance of corrosion of reinforced concrete (R-C) structures, and since predictions of their residual service life and monitoring and control of the effectiveness of a chosen corrosion protective measures generally require a method for measuring the rate of corrosion, reliable and fast detection of corrosion and the evaluation of its rate have attracted the interest of researchers. Gravimetric weight loss technique is a simple but the most reliable method established for the study of metallic corrosion. However, due to its time consuming and destructive nature, it is not applicable for the assessment of real R-C structures. Nevertheless, it remains a reliable reference method for verification of the validity of other techniques, such as electrochemical methods.

Non-destructive but indirect methods, such as the measurement of corrosion potential (E_{corr}) and concrete resistivity, have been developed for the detection of corrosion in steel reinforcement bars or rebars. These methods, however, provide only qualitative, or at best, semi-quantitative information. Electrochemical methods, which offer non-destructive detection and quantitative measurement of corrosion rate in steel-concrete systems, are the most widely applied methods for the study of rebar corrosion in recent times. Some popular electrochemical methods include linear polarization or polarization resistance (Rₚ), coulostatic, electrochemical noise, electrochemical impedance spectroscopy (EIS) or A.C. impedance methods. Out of these techniques, the most widely used method for quantitatively assessing the corrosion kinetics of metallic materials, both on-site and in the laboratory, is the polarization resistance (Rₚ) method.

Many testing devices have been developed employing the polarization resistance method. These devices automate potential sweep and data gathering processes in order to obtain the corrosion rate of a rebar embedded in concrete with minimal effort. This has made in-situ assessment and lab studies on rebar corrosion rates very easy. However, these devices tend to be very expensive, and they are typically designed for testing a single specimen at a time. In laboratories where hundreds of specimens must be tested for research, development, and performance verification works, the prospect can be daunting, repetitious, and overly time-consuming. Consider for example that a typical testing interval lasts for about ten minutes per specimen, in which a lab technician prepares the specimen to be tested, runs the test, and manually notes the results thereof. It can be seen that this process increases the potential for human error. Thus, many reported inconsistencies applying the same electrochemical technique in varying conditions, particularly in passive systems, may result from incorrect application of the particular electrochemical technique in question, rather than the technique itself being unable to capture the behavior of the steel-concrete system.

Thus, a sequencer system for data collection of a plurality of corrosion specimens solving the aforementioned problems is desired.

### SUMMARY OF THE INVENTION

The sequencer system for data collection of corrosion specimens includes a container for holding a plurality of specimens to be tested, and during testing, the container holds a solution bath. A reference electrode and a counter electrode are coupled to a potentiostat, both electrodes being operationally disposed inside the container. A sequencer is connected to each specimen via a working electrode line. The sequencer operates in concert with the potentiostat to switch between a tested specimen and a subsequent specimen to be tested during a pause phase between each polarization cycle of the potentiostat. A computer is coupled to the potentiostat and the sequencer, and a program controls synchronized operations between the potentiostat and the sequencer. The program also permits automatic data collection for each specimen.

These and other features of the present invention will become readily apparent upon further review of the following specification and drawings.

### BRIEF DESCRIPTION OF THE DRAWINGS

FIG. 1 is a schematic diagram of a sequencer system for data collection of corrosion specimens according to the present invention.

FIG. 2 is a schematic diagram of a container in the sequencer system for data collection of corrosion specimens of FIG. 1, showing connections between the potentiostat and the specimens.

FIG. 3 is a timing diagram showing the interaction between the operating cycles of a potentiostat and a sequencer in the sequencer system for data collection of corrosion specimens shown in FIG. 1.

FIG. 4 is an operational flowchart of the sequencer system for data collection of corrosion specimens shown in FIG. 1 and a program therefore.

FIG. 5 is a graph of data results comparing data between a conventional data collection system and the sequencer system for data collection of corrosion specimens shown in FIG. 1.

FIG. 6 is a schematic diagram of a prior art data collection system.

FIG. 7 is a circuit diagram of a prior art data collection system.

Similar reference characters denote corresponding features consistently throughout the attached drawings.

### DETAILED DESCRIPTION OF THE PREFERRED EMBODIMENTS

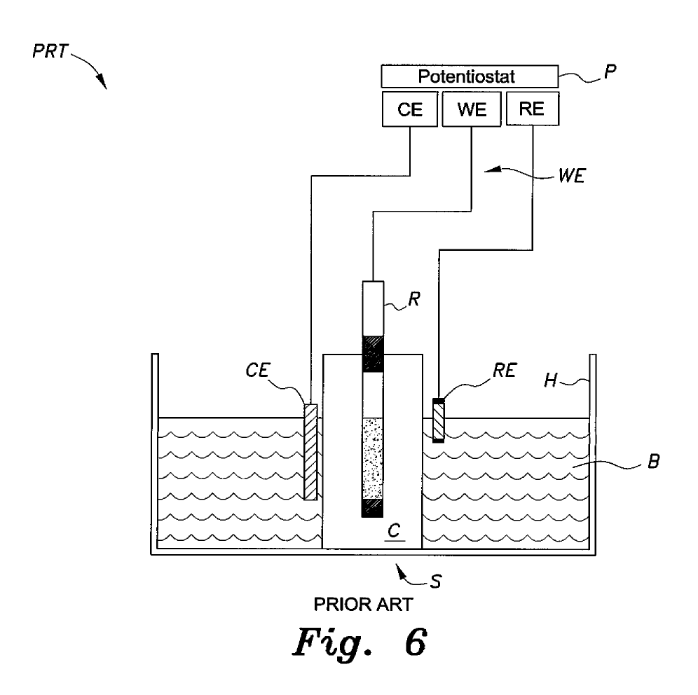

The sequencer system for data collection of corrosion specimens, generally referred to by the reference number 100 in the drawings, provides a relatively inexpensive testing setup that facilitates serial testing of a plurality or multiple specimens in a single session. For comparison, a conventional linear polarization resistance (LPR) testing system PRT is shown in FIG. 6 in which a single sample or specimen S is prepared to undergo the testing process.

The conventional testing system PRT includes a container H filled with a bath solution B. The solution B preferably contains about 5% NaCl or any other electrolyte of any concentration. The specimen S is a “lollipop” configuration in which a rebar section R protrudes out of a concrete cylinder C forming a general lollipop or ice cream stick shape. The specimen S is placed between a counter electrode CE and a reference electrode RE. A working electrode WE is selectively coupled to the rebar section R to obtain current (potentiostatic mode) or potential (galvanostatic mode) readings from the rebar section R. The counter electrode CE, the reference electrode RE, and the working electrode WE are all coupled to a potentiostat P, which controls the electroanalytical functions for the testing process. In a traditional testing procedure, the single working electrode WE is sequentially coupled to each subsequent specimen to be tested after the prior specimen has been tested. Once a specimen has been tested, the working electrode WE is decoupled from the tested specimen, and the tested specimen removed from bath B. Then the working electrode WE is coupled to the subsequent specimen to be tested and placed into bath B. The order of couplings and specimens can be facilitated in any manner. However, the preparation and testing of the specimen is performed on a one by one basis, rather than in a batch. It can be readily seen from the above that many manual and time-consuming steps are involved in testing a plurality of specimens one at a time.

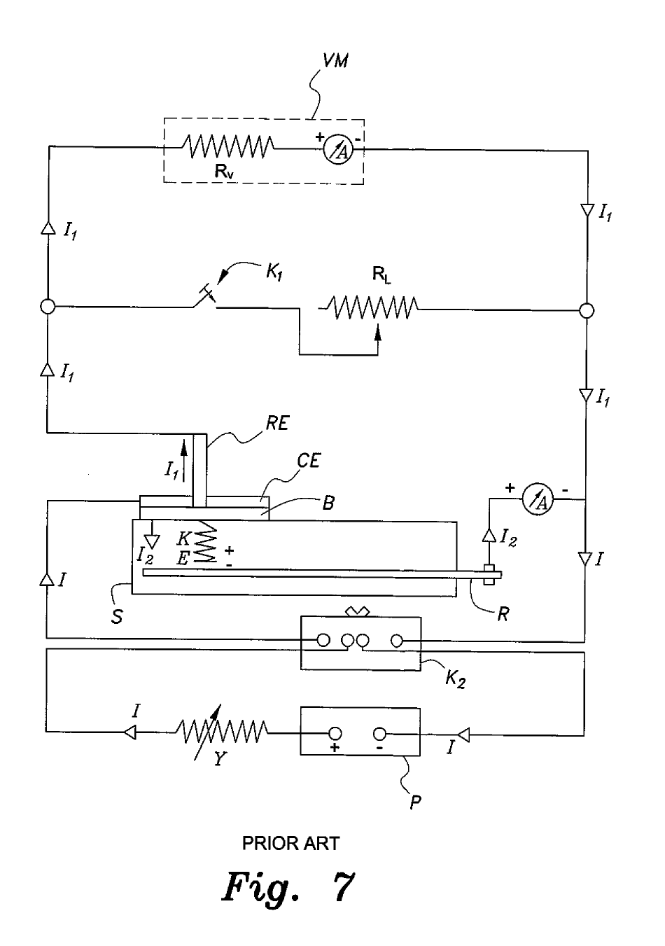

The measurement procedure for obtaining corrosion current density, I_{corr}, is best seen with reference to FIG. 7. Keeping K₁ and K₂ open, the stable corrosion potential (E_{corr}) can be measured and recorded with the aid of a voltmeter VM, after allowing a sufficient response time of 30-60 seconds. Keeping K₂ closed, a cathodic polarizing current, I₂, can be applied in steps (ΔI) while the system potential response (ΔE) is read and recorded (galvanostatic mode), or vice-versa (potentiostatic mode), the recording being usually performed manually. It is customary to apply the potential sweep over a range of 20 mV, from −10 mV to +10 mV of E_{corr}. The corrosion current density, I_{corr}, can be evaluated using a

Stern-Geary relationship:

$${I}_{corr} = \frac{B}{{R}_{p}}$$

where:

I_{corr}=Corrosion current density, μA/cm²;

Rₚ=Resistance to polarization, ΔE/ΔI, Ω·cm²;

$$B = \frac{{β}_{a} \times {β}_{c}}{2.3 ( {β}_{a} + {β}_{c} )} ;$$

and

βₐ and β_{c} are the anodic and cathodic Tafel constants, mV/decade, respectively.

The Tafel constants are normally obtained by polarizing the steel in the rebar section R to ±250 mV of the corrosion potential (Tafel plot). However, in the absence of sufficient data on βₐ and β_{c}, a value of B equal to 26 mV for steel in active condition and 52 mV for steel in passive condition is often used.

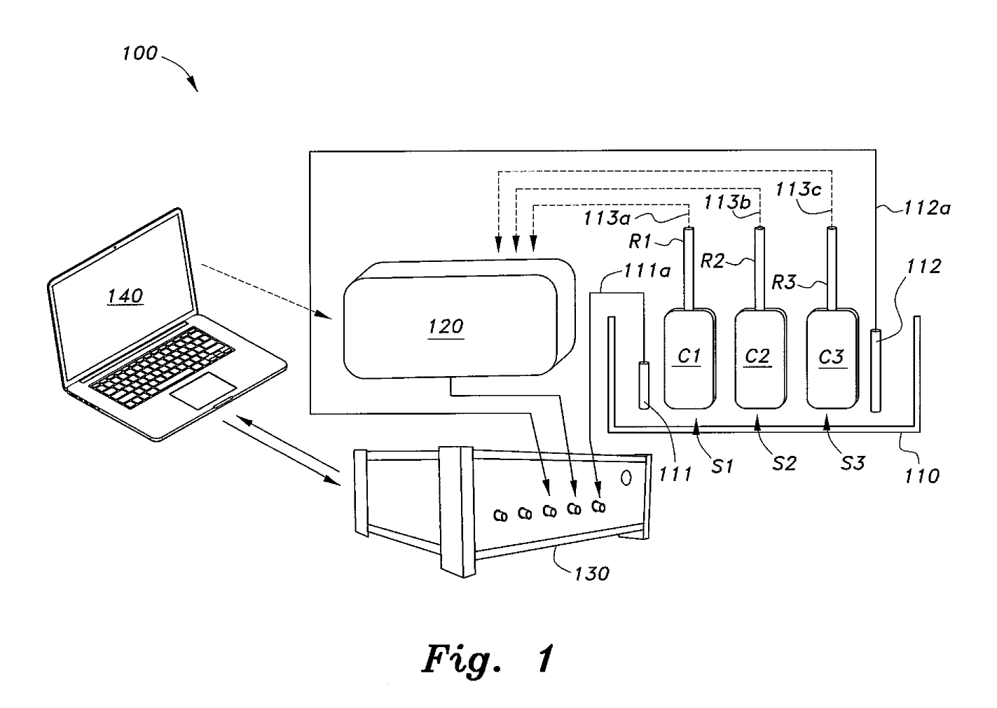

In contrast to the conventional setup, the present sequencer system 100 for data collection of corrosion specimens, as best seen in the diagrammatic view shown in FIG. 1, includes a specimen container or tank 110 configured to simultaneously hold a plurality of specimens S1, S2, S3 therein; a reference electrode 111; a counter electrode 112; a sequencer 120; a potentiostat 130; and a computer 140. Each specimen S1, S2, S3 is preferably of conventional construction of a cylindrical concrete block C1, C2, C3 having a respective, embedded rebar section R1, R2, R3 protruding out of the corresponding concrete block C1, C2, C3. It is to be noted that although the drawings show a specific number of specimens, the actual number can be varied.

The container 110 is normally filled with the bath solution B mentioned above during testing. It is to be noted that the container 110 does not need to be a discrete constructed or manufactured container. The container 110 can be any type of structure or environment that can hold a bath B with one or more specimens exposed for testing. For example, the container 110 can be an in-situ exposure site, such as in the middle of an ocean, in which case the seawater can serve as the bath solution B or the reference electrode 111 and the counter electrode 112 can be placed on the surface of a structure with suitable connection to the reinforcement cage in a reinforced concrete structure. Referring back to FIG. 1, the reference electrode 111 and the counter electrode 112 are selectively placed near opposite ends of the specimen container 110 during setup, and the specimens S1, S2, S3 are placed between the reference electrode 111 and the counter electrode 112. Other arrangements of the reference electrode 111, the counter electrode 112, and the specimens S1, S2, S3 within the container 110 are also possible during setup. A reference electrode line 111a extends from the reference electrode 111 and is selectively coupled to the potentiostat 130. Similarly, the counter electrode 112 includes a counter electrode line 112a extending therefrom, which is selectively coupled to the potentiostat 130.

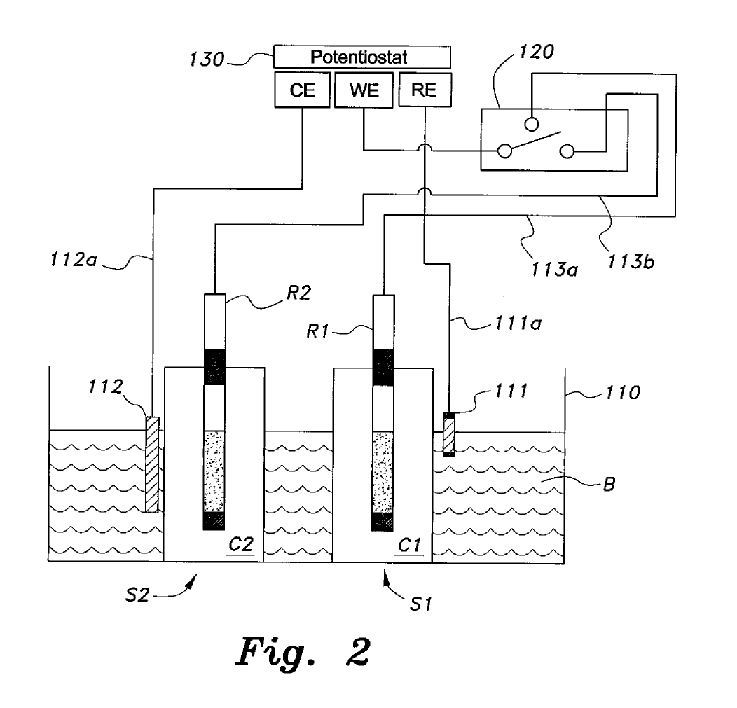

Each rebar section R1, R2, R3 acts as an individual working electrode and includes respective working electrode lines 113a, 113b, 113c extending from a corresponding rebar section R1, R2, R3. Since each rebar section R1, R2, R3 acts as an individual working electrode, there can be more than one rebar section embedded in each specimen S1, S2, S3. The working electrode lines 113a, 113b, 113c are individually coupled to the sequencer 120 in parallel. As best seen in FIG. 2, the sequencer 120 functions as a switchboard that closes the circuit to each working electrode line 113a, 113b, 113c in a preprogrammed, sequential manner.

A computer 140 is operatively coupled to the sequencer 120 and the potentiostat 130 to control the respective operations thereof. A program 150 has been developed to synchronize the operational cycles of the potentiostat 130 with the electrode switching sequence of the sequencer 120. The program 150 utilizes the preprogrammed operational characteristics of the potentiostat 130 to facilitate the electrode switching. In one respect, the program 150 acts as a driver that controls the electrode switching process of the sequencer 120, which enables coupling or closing of the circuit from one specimen to another. The program 150 is installed and configured in the computer 140 and facilitates automated detection of the completion of the polarization run of the previously coupled specimen by the potentiostat 130. To increase smooth transition to the next specimen, the potentiostat 130 can be configured to impose an additional pause for about 2-4 seconds as needed before each polarization run to create what is later referred to as the idle phase.

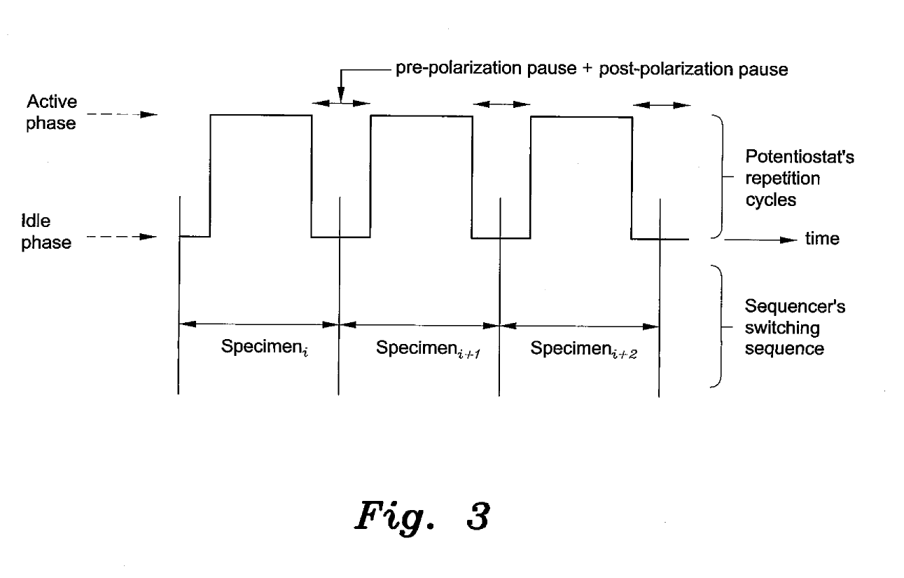

To illustrate, the potentiostat 130 undergoes repetitive polarization cycles during testing as best seen in FIG. 3. Each cycle includes an idle phase and an active phase. The idle phase is composed of a pre-polarization pause and a post-polarization pause, each of which can be about 0-4 seconds with an insured minimum of about 2-4 seconds by the imposition of an additional pause through a configuration of the potentiostat 130 as noted above, and the program 150 utilizes the time period of the idle phase pauses to switch from one working electrode or test specimen to another vis-à-vis the sequencer 120.

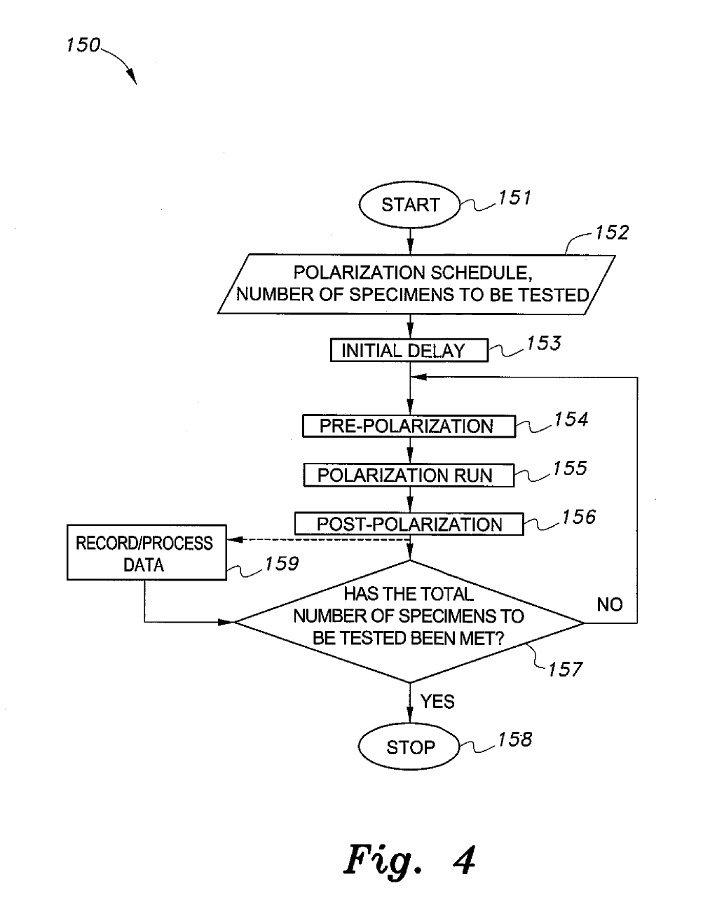

The steps involved in the system are shown in the flow diagram of FIG. 4, which represents a single testing session of multiple specimens. After start 151, a software interface of the potentiostat 130 which has been installed in the computer 140 is initialized or input with the various parameters of a polarization schedule of the testing to be performed, such as the number of specimens, the voltage ranges, the data file name, and the like, as seen by step 152. This input step is the same as in a single specimen setup with repeated runs. However, the data file name entered on the software interface of the potentiostat 130 can be copied to or synchronized with the user interface of the program 150, so that the program 150 can detect or monitor completion of a polarization run per each specimen in a batch. This is indicated by the appearance of a new data item in a data file in a storage memory of the computer 140. The initial delay step 153 provides time for the system to warm up and be prepared for subsequent polarization steps. The initial delay step 153 (which may be omitted without any negative consequence) provides time for the system to warm up and be prepared for subsequent polarization steps.

Steps 154, 155, and 156 follow the polarization cycle shown in FIG. 3, where for a given specimen being tested, the potentiostat 130 performs a cycle of pre-polarization pause at step 154, polarization run at step 155, and finishes with a post-polarization pause at step 156. If only a single specimen is being tested, then the process would stop here. However, if multiple specimens are being tested, then the process follows the interrogatory at step 157 which determines if the desired or designated number of specimens has been tested. If “Yes,” then the process stops at step 158. If “No,” then steps 154, 155, and 156 repeat until all the specimens have been tested. During the transition between the pre-polarization step 154 and post-polarization step 156, the program 150 commands the sequencer 120 to open the circuit to the tested working electrode, e.g., working electrode 113a, and close the circuit to the subsequent working electrode, e.g., working electrode 113b, connected to the next specimen to be tested.

Since the computer 140 is connected to the sequencer 120 and the potentiostat 130 and control operations thereof, the program 150 can include an additional step 159 in which data from the steps 154, 155, and 156 can be recorded and/or processed for each specimen. The recorded data can then be compiled into one or more databases, spreadsheets, or other formats that facilitate easy and accessible corrosion analysis of the tested specimens. Additionally, the sequencer 120 and the potentiostat 130 need not be in communication with each other. They can operate independently without such communication. As long as the data file name entered on the software interface of the potentiostat 130 is copied to the user interface of the program 150, the program 150 can seamlessly synchronize operations between the potentiostat 130 and the sequencer 120. The order of specimens being tested can also be set by the program 150.

Data degradation, integrity, or accuracy may be a concern by the above setup in which multiple specimens S1, S2, S3 are placed and tested in the same container 110. In other words, a question can arise as to whether the presence of a specimen in a cell can affect the polarization process of a neighboring specimen. Simple technical reasoning would lead one to believe there would not be any interaction among the specimens S1, S2, S3, as long as all others are on open circuit, except the one that is currently being polarized. Another reason is that it is a normal practice to test an individual specimen to measure the corrosion potential in the presence of others, except that only a single specimen is tested at a time, and this measurement is facilitated by physical attachment of a single working electrode line to the specimen to be tested.

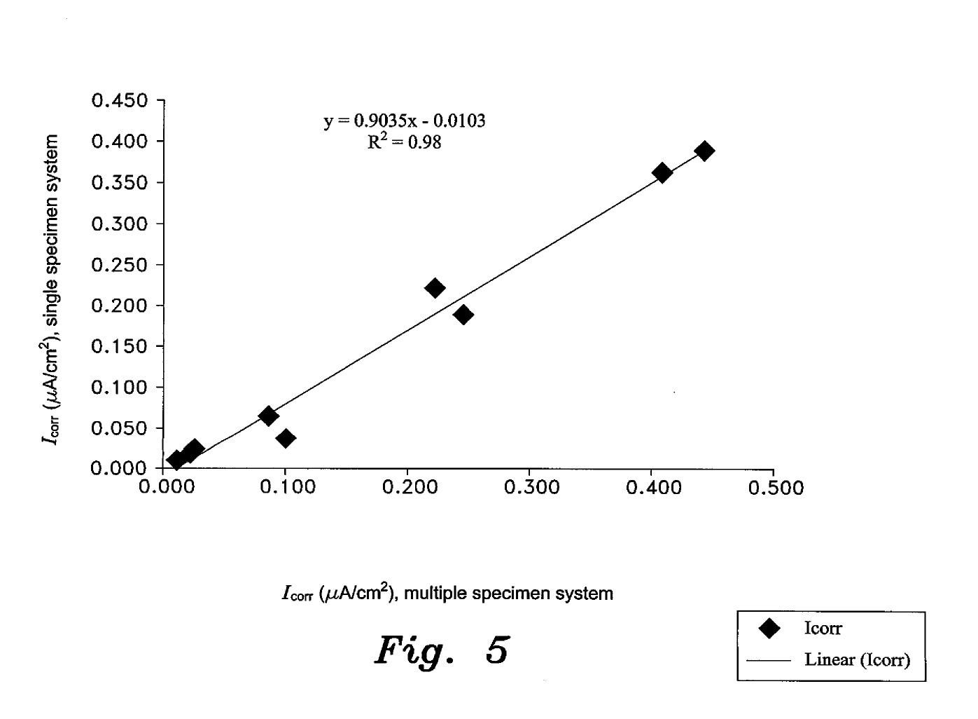

In order to test whether any interaction occurs between adjacent specimens during a polarization run, an experiment was conducted with nine specimens, first in the conventional single specimen setup and then in sequencer system 100. The results are shown in FIG. 5. The graph therein shows the plot of the single specimen system results, the linear or straight line I_{corr}, against that of the sequencer system 100, the plot points I_{corr}. It can be seen from the graph that there is no practical difference between the two sets of results. The data spread of I_{corr} values can be attributed to slight noise from successive runs of the same specimen. They are, however, within acceptable levels of deviation.

Thus, it can be seen that the sequencer system 100 for data collection of corrosion specimens provides a relatively easy and inexpensive solution to testing and obtaining data compared to conventional setups. The sequencer system 100 can facilitate testing of a batch of 16 specimens as an example of the actual number of specimens processed by the sequencer 120. The sequencer 120 can handle more, depending on the hardware architecture therein. This setup is far less expensive compared to polypotentiostats that can be used to test more than one specimen, but polypotentiostats are also generally limited in the actual number of specimens that can be processed, this number being typically less than the capacity of the sequencer 120.

It is to be understood that the present invention is not limited to the embodiments described above, but encompasses any and all embodiments within the scope of the following claims.

We claim:

1. A sequencer system for corrosion data collection of specimens, comprising:
a container adapted to hold a plurality of specimens and a solution bath therein;
a reference electrode disposed near one inner side of the container;
a counter electrode disposed near another inner side of the container, the plurality of specimens being placed between the reference electrode and the counter electrode during a testing session;
a potentiostat coupled to the reference electrode and the counter electrode, the potentiostat facilitating a plurality of polarization cycles during the testing session;
a sequencer coupled to each of the specimens, the sequencer selectively switching connection to specimens between each polarization cycle of the potentiostat; and
a computer coupled to the potentiostat and the sequencer, the computer having a program for controlling synchronized operations of the potentiostat and the sequencer to thereby obtain data from each specimen during a single testing session.

2. The sequencer system for corrosion data collection of specimens according to claim 1, wherein said sequencer comprises:
a plurality of working electrode lines, each working electrode line being coupled to a respective specimen; and
a circuit communicating with each working electrode, the circuit selectively opening connection to a tested specimen and closing connection to a subsequent specimen to be tested between each polarization cycle of the potentiostat.

3. The sequencer system for corrosion data collection of specimens according to claim 1, wherein each of the polarization cycles comprises an idle phase and an active phase, the idle phase being divided into a pre-polarization pause and a post-polarization pause, said sequencer switching connection between one of the specimens to another during the idle phase.

4. The sequencer system for corrosion data collection of specimens according to claim 3, wherein said program for controlling synchronized operations of said potentiostat and said sequencer comprises:
means for establishing a number of specimens to be tested from the plurality of specimens;
means for operating said potentiostat to run said polarization cycle on a specimen; and
means for repeating the step of operating said potentiostat for each specimen until all of the specimens have been tested, said sequencer opening connection to a tested specimen and closing connection to the subsequent specimen to be tested during said idle phase in each of the polarization cycles.

5. The sequencer system for corrosion data collection of specimens according to claim 4, wherein said program for controlling synchronized operations of the potentiostat and the sequencer further comprises means for recording data from each tested specimen for further processing and analysis.

6. A method of collecting corrosion data from specimens, comprising the steps of:
providing a sequencer system, the sequencer system comprising:
a container adapted to hold a plurality of specimens and a solution bath therein;
a reference electrode disposed near one inner side of the container;
a counter electrode disposed near another inner side of the container, the plurality of specimens being placed between the reference electrode and the counter electrode during a testing session;
a potentiostat coupled to the reference electrode and the counter electrode, the potentiostat facilitating a plurality of polarization cycles during the testing session;
a sequencer adapted to be coupled to each specimen, the sequencer switching connection to select specimens between each polarization cycle of the potentiostat; and
a computer coupled to the potentiostat and the sequencer, the computer having a program for controlling synchronized operations of the potentiostat and the sequencer;
extending a working electrode line between the sequencer and each specimen to couple the sequencer to each specimen;
supplying the container with the bath solution; and
running the program to test all the specimens, the program controlling the sequencer and monitoring polarization activities in the potentiostat to facilitate the sequencer switching connection between specimens during pauses between polarization cycles.

7. The method of collecting corrosion data from specimens according to claim 6, further comprising the steps of
establishing a number of specimens to be tested from the plurality of specimens;
operating said potentiostat to run said polarization cycle on a specimen; and
repeating the step of operating said potentiostat for each specimen till all the number of specimens have been tested.

8. The method of collecting corrosion data from specimens according to claim 7, further comprising the step of recording data from each tested specimen for further processing and analysis.
